(19) United States
(12) Patent Application Publication
(10) Pub. No.: US 2006/0165836 A1
(43) Pub. Date: Jul. 27, 2006

(54) Apparatus and method for forming materials

(76) Inventors: Friedrich Wilhelm Ludwig Paul Vollrath, Oxford, Oxford Shyer (GB); David Philip Knight, Winchester Hampshire (GB)

Correspondence Address: INTELLECTUAL PROPERTY / TECHNOLOGY LAW, PO BOX 14329, RESEARCH TRIANGLE PARK, NC, 27709, US

(21) Appl. No.: 10/535,093

(22) PCT Filed: Nov. 14, 2003
(86) PCT No.: PCT/EP03/13031

§ 371 Date: Jul. 28, 2005

(30) Foreign Application Priority Data
Nov. 14, 2002 (GB) 0226576.7

(51) Int. Cl. B29C 47/00

(52) U.S. Cl. 425/382 R

(57) ABSTRACT

An extrusion apparatus, which comprises at least one first reservoir, connected at a first end to a first opening of a plurality of regulatory modules. The regulatory modules or spinnerets contain tubular passages through which dope material is excludable. The extrusion apparatus has at least 1,000 of the tubular passages per square meter cross-section.

### TECHNICAL FIELD

This invention relates to an apparatus and method for forming extruded material, such as filaments, fibres, ribbons, sheets or other solid products, from a liquid solution, such as a polymer solution (which term includes a protein solution or cellulose solution).

### BACKGROUND ART

Methods of producing filaments or fibres gave been known in the art for a long time. For example, spinning techniques are used to produce fibres from polymer solutions. British patent specification GB-A441 440 (Ziegrer) discloses one technique in which filaments are produced by passing a liquid raw material to be solidified through a porous porcelain tube. The filaments emerge from the end of the porous porcelain tube in this disclosure. An operative medium is introduced into the porous porcelain tube through the pores of the tube.

There is currently considerable interest in the development of improved processes and apparatus to enable the manufacture of polymer filaments, fibres, ribbons or sheets. It is theoretically possible to obtain materials with high tensile strength and toughness by engineering the orientation of the polymer molecules and the way in which they intereact with one another. Strong, tough filaments, fibres or ribbons are useful in their own right for the manufacture, for example, of sutures, threads, cords, ropes, wound or woven materials. They can also be incorporated into a matrix with or without other filler particles to produce tough and resilient composite materials. Sheets whether formed from fibres or ribbons can be stuck together to form tough laminated composites.

Natural silks are fine, lustrous filaments produced by the silk-worm Bombyx mori and other invertebrate species. They offer advantages compared with the synthetic polymers currently used for the manufacture of materials. The tensile strength and toughness of the dragline silks of certain spiders can exceed that of Kevler™, the toughest and strongest man-made fibre. Spider dragline silks also possess high thermal stability. Many silks are also biodegradable and do not persist in the environment. They are recyclable and are produced by a highly efficient low pressure and low temperature process using only water as a solvent. The natural spinning process is remarkable in that an aqueous solution of protein is concerted into a tough and highly insoluble material.

According to an article by J. Magoshi Y. Magoshi, M. A. Becker and S. Nakamura entitled “Biospinning (Silk Fiber Formation, Multiple Spinning Mechanisms)” published in Polymeric Materials Encyclopedia, by the Chemical Rubber Company, it is reported that natural silks are produced by sophisticated spinning techniques which cannot yet be duplicated by man-made spinning technologies.

Fibres produced by existing technological processes and apparatus suffer from the following disadvantages. Many show “die swell” which leads to some loss of molecular orientation with a consequent degradation of mechanical properties. Furthermore, existing processes are not energy efficient, requiring high temperatures and pressures to reduce the viscosity of the feedstock so that it can be forced trough a die. Separate stages are often required, for example for further “draw-down”, to anneal the fibre with heat, and to process it through separate acid or alkaline treatment baths.

One example of an improved method for producing fibres is known from European Patent Application EP-A-0 656 433 (Filtration Systems, Inc. and Japan Steel Works, Ltd.) which teaches a nozzle plate with a plurality of spinning holes. This document fails, however, to address the problem of die swell which occurs when the spun fibre or filament emerges from the exit of the nozzle plate.

A system for producing a multi-ingredient composite fibre is known from European patent application EP-A-0 104 081 (Toray Industries). This application discloses a spinneret assembly for producing “island-in-sea” type fibres using multiple feedstocks. The spinneret assembly can have more than one nozzle for concurrently producing more than one fibres. This document fails, however, to teach the size of the fibres and the dimensions of the apparatus.

### SUMMARY OF THE INVENTION

There remains a need to rapidly produce a large number of high-strength fibres.

These and other objects of the invention are solved by providing an extrusion apparatus with at least one first reservoir connected at a first end to a first opening of plurality of regulatory modules containing passages through which material is extrudable. The extrusion apparatus has at least 1,000 passage per square metre cross-section. Using this apparatus a large number of fibres can be rapidly produced. The passages can be, for example, tubular or ribbon-shaped.

In one advantageous embodiment of the extrusion apparatus the regulatory module additionally comprises at least one second reservoir. The use of a second reservoir allows a multi-component fibre to be produced.

The extrusion apparatus further comprises sensors, such as pressure sensors, temperature sensors, chemical sensors, pH sensors and/or light-scattering sensors. These sensors measure the parameters of the extrusion process and allow rapid adjustment of the extrusion conditions, if required.

Preferably the sensors are integral to the regulatory modules. In this embodiment, the sensors are not constructed as separate entities, but are formed as part of the regulatory modules.

The extrusion apparatus can also have pumps in the regulatory modules for pumping feedstocks through the extrusion apparatus. Such pumps can be piezo-electric, vibration pumps or other known pumps.

The passages may have flow inlets. These flow inlets allow the addition of further material to the feedstock during the extrusion process. Such further material could include dopants which alter the properties of the final extruded material. The further material can also modify the extrusion process in advantageous manner.

In one aspect of the invention, the interior walls of the tubular passages are made of a permeable material. This allows further material to diffuse through the interior walls to be incorporated into the final extruded materials. The regulatory modules can be made, for example, either by injection moulding or laser ablation.

In order to avoid problems of die swell, which may lead to a reduction of mechanical strength of the application in operation the material is drawn down at a first distance at least 0.5 mm from an outer exit opening within the tubular passages.

Internal draw-down is aided by providing a ridged surface on the internal surface of the tubular passage. The height of the ridges on the ridged surface are typically less than 10% than the diameter of tubular passage. The ridges on the ridged surface are substantially continuous and are substantially oriented parallel to the long axis of the tubular passages. The ridges are preferably constructed from or coated with a hydrophobic material.

### DISCLOSURE OF THE INVENTION

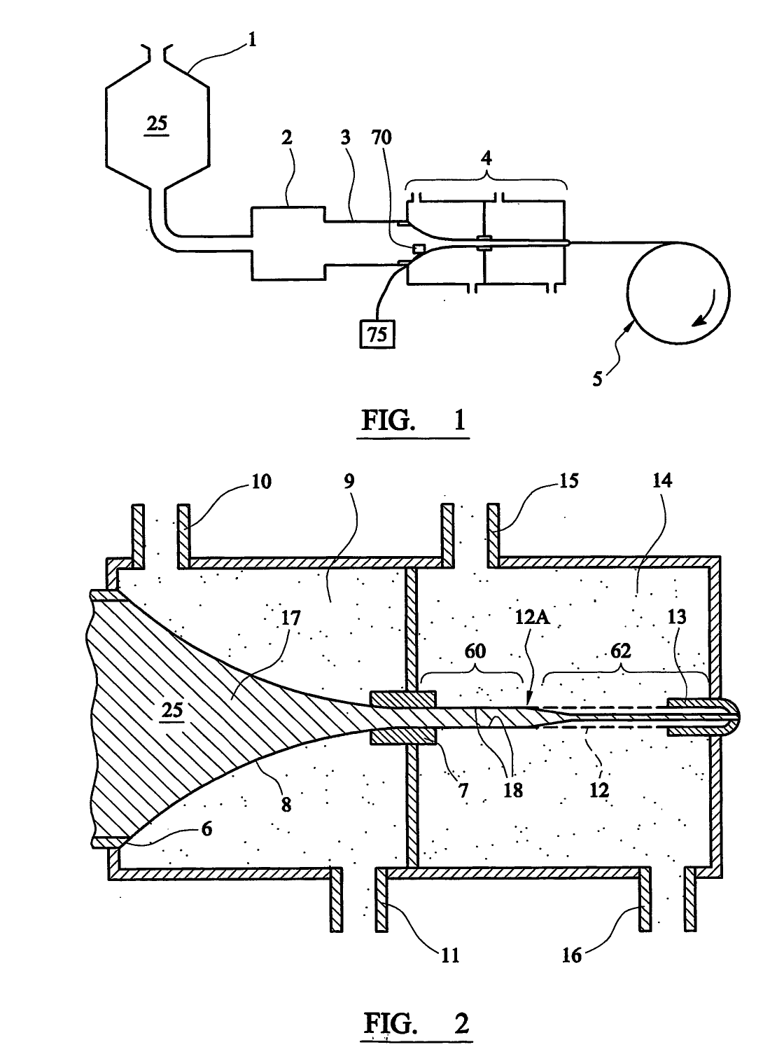

FIG. 1 is a generalised schematic representation of apparatus for the formation of extruded materials form a spinning solution;

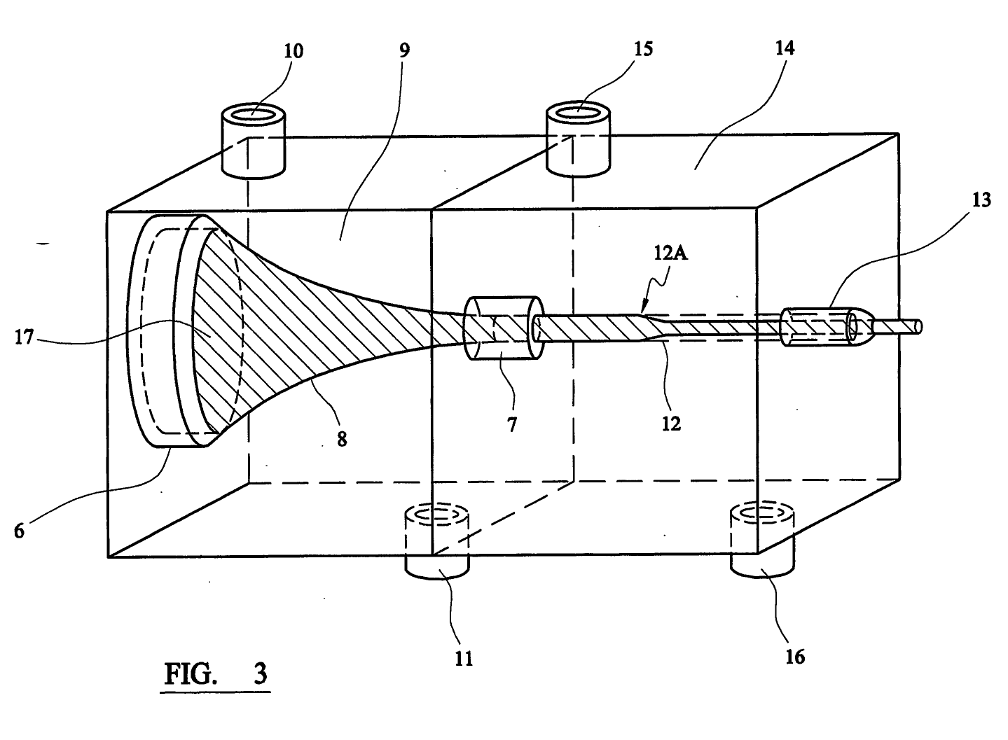

FIG. 2 is a schematic cross-sectional view along the longitudinal axis of a die assembly of the apparatus shown in FIG. 1;

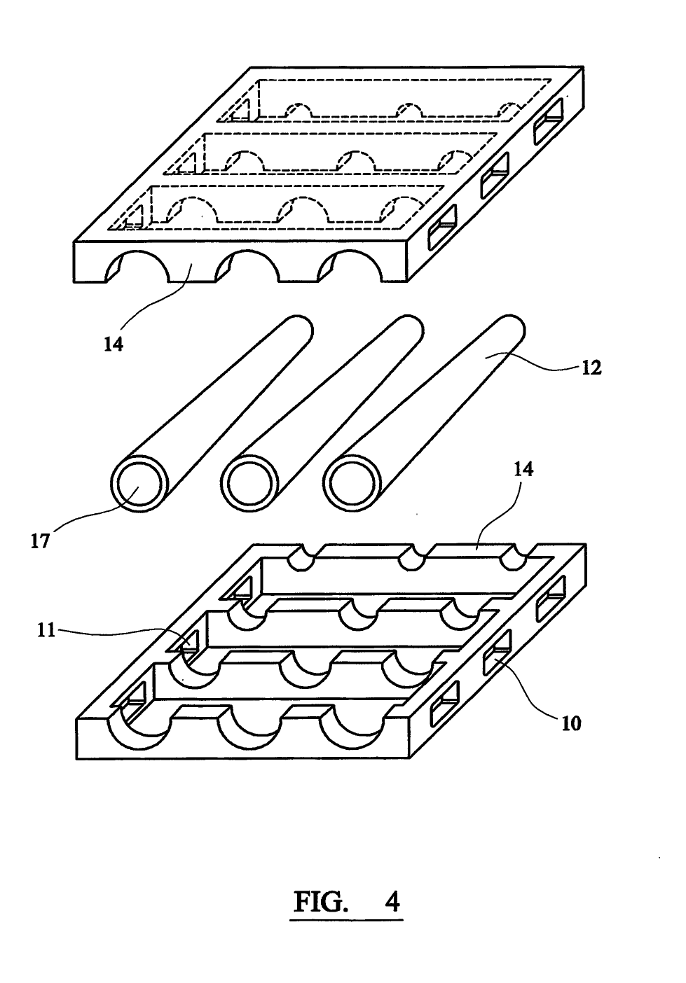

FIG. 3 is a schematic perspective view of the die assembly shown in FIG. 2;

FIG. 4 is a schematic exploded view illustrating another embodiment of a die assembly of apparatus according to the invention; and

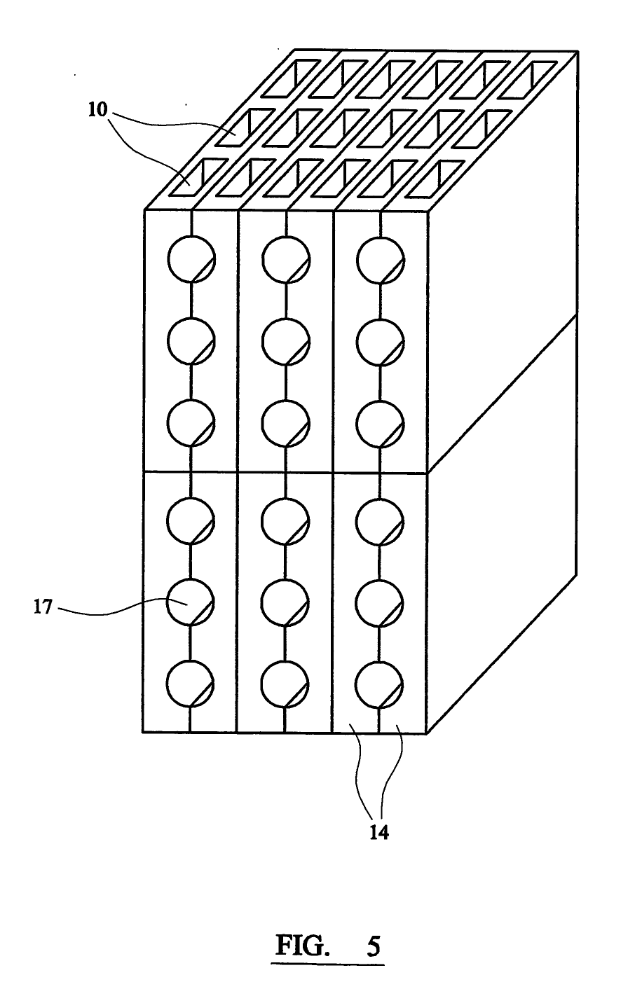

FIG. 5 is a view showing a number of die assemblies of FIG. 4 assembled together in a unit to enable a plurality of fibres to be extruded.

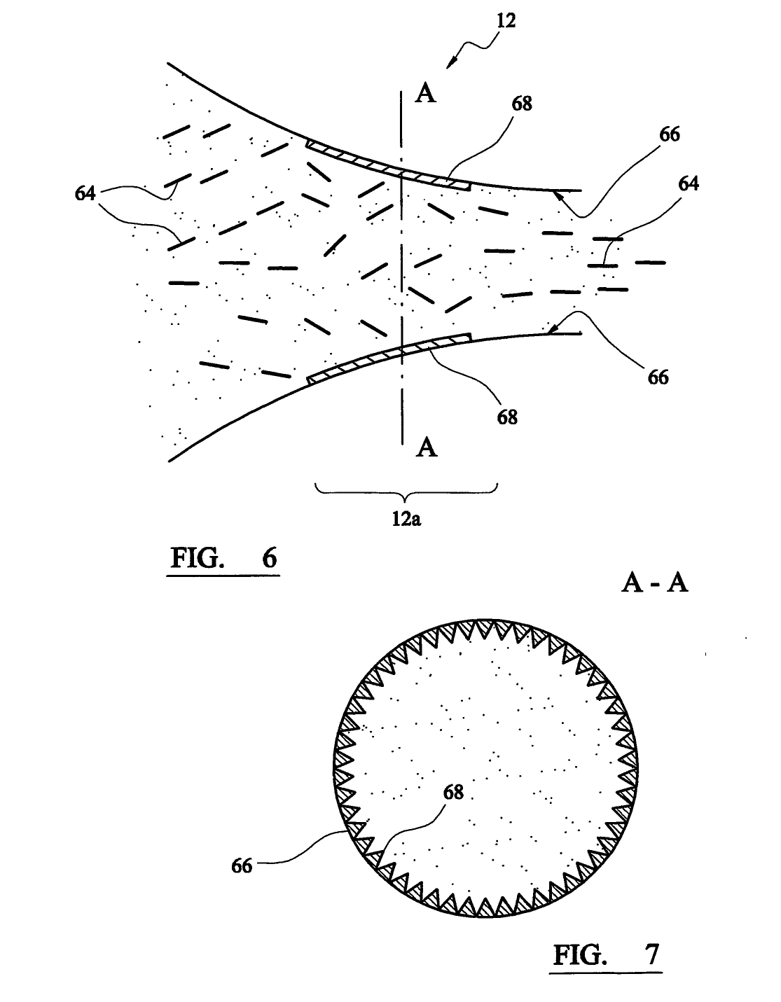

FIG. 6 is a view illustrating tumbling of rod-shaped elements in the tubular passage.

FIG. 7 is a cross-sectional view of the tubular passage.

### DETAILED DESCRIPTION OF THE INVENTION

The discovery of the way in which spiders produce dragline silk provides the basis for the invention. We have found that by making the walls of the or each tubular passage at least partly permeable or porous, preferably selectively permeable along the length of the tubular passage, which is preferably tapered, it is possible to control properties such as the pH, water content, ionic composition and shear regime of the spinning solution in different regions of the tubular passage of the die. Ideally this enables the phase diagram of the spinning solution to be controlled allowing for pre-orientation of the fibre-forming molecules followed by a shear-induced phase separation and allowing the formation of insoluble fibres containing well-orientated fibre, forming molecules.

Conveniently the walls defining the tubular passage(s) are surrounded by said enclosure means to provide one or more compartments. These compartments act as jackets around the tubular passage(s). The or each tubular passage suitably has an inlet at one end to receive the spinning solution and an outlet at the other for the formed or extruded material and is typically divided into three parts arranged consecutively, the first part or initial zone allowing for the pre-treatment and pre-orientation of the fibre-forming polymer molecules in the liquid feedstock prior to forming the material by draw down, the second region or subsequent zone in which draw down of the “thread” takes place and which functions as a treatment and coating bath, and the third part or final zone has an outlet or opening of restricted cross-section which serves to prevent the loss of the contents of the “treatment bath” with the emerging fibre and to provide for the commencement of an optional air drawing stage.

It will be appreciated that any solution or solvent or other phase or phases surrounding the fibre in the second part of the or each tubular passage also serves to lubricate the fibre as it moves through and out of the tubular passage.

In a further aspect of the invention, the walls of the or each tubular passage may contain flow inlets through which further material can be introduced into the tubular passage. The further material can either alter the conditions under which the extrusion process is performed or can be incorporated as dopant in the final extruded material.

In an embodiment of the invention, an opening into and surrounding the first zone or second zone of the tubular passage allows the introduction of a coating onto the surface of the fibre or extruded material.

All or part of the length of each tubular passage typically has a convergent geometry typically with the diameter decreasing in a substantially hyperbolic fashion. According to G. Y. Chen, J. A. Cuculo and P. A. Tucker in an article entitled “Characteristic and Design Procedure of Hyperbolic Dies” in the Journal of Polymer Sciences: Part B: Polymer Physics, Vol 30, 557-561 in 1992, it is reported that the orientation of molecules in a fibre can be improved by using a die with a convergent hyperbolic geometry instead of the more usual parallel capillary or conical dies.

The geometry of substantially all or part of the or each tubular passage may be varied to optimise the rate of elongational flow in the spinning solution (dope) and to vary the cross-sectional shape of the formed material produced from it. The preferred substantially hyperbolic taper for part or all of the or each tubular passage maintains a slow and substantially constant elongational flow rate thus preventing unwanted disorientation of the fibre-forming molecules resulting from variation in the elongational flow rate or from premature formation of insoluble material before the dope has been appropriately reoriented. A convergent taper to the tubular passage of the die will induce elongational flow which will tend to induce a substantially axial alignment in the fibre-forming molecules, short fibres or filler particles contained in the dope by exploiting the well known principle of elongational flow. Alternatively, the principle of elongational flow through a divergent part of a die instead of the convergent die can be used to induce orientation in the hoop direction that is substantially transverse to the direction of flow through the divergent part of the die.

The diameter of the or each tubular passage may be varied to produce fibres of the desired diameter. In the embodiment of the invention disclosed herewith, the diameter of the or each tubular passage has to be chosen such that at least 1000 fibres are produced per square meter.

The rheology of the liquid feedstock in the tubular passage of the die is largely independent of scale, thus enabling the size of the apparatus to be scaled up or down. The convergence of the tubular passage allows a wide range of drawing rates to be used typically ranging from 0.01 to 1000 mm sec⁻¹. If fibres are being extruded they may typically have a diameter of from 0.1 to 100 μm. Typically the outlet of the tubular passage has a diameter of from 1 to 100 mm with the diameter of the inlet of the tubular passage being from 25 to 150 times greater depending on the extensional flow it is desired to produce. Tubular passages of alternative cross-sectional shapes can be used to produce fibres, flat ribbons or sheets of extruded materials with other cross-sectional shapes.

All or part or parts of the walls of the or each tubular passage of the die assembly are constructed from or formed or moulded from selectively permeable and/or porous material, such as cellulose acetate-based membrane sheets. The membrane can be substituted with diethylaminoethyl or carboxyl or carboxymethyl groups to help maintain protein-containing dopes in a state suitable for spinning. The membrane can also be rendered substantially hydrophobic with a siliconizing or silanizing solution or with polytetrafluoroethylene particles. Other examples of permeable and/or porous material are hollow-fibre membranes, such as hollow fibres constructed from polysulfone, polyethyleneoxide-polysulfone blends, silicone or polyacrylonitrile. The exclusion limit selected for the semipermeable membrane will depend on the size of the small molecular weight constituents of the dope but is typically less than 12 kDa.

All or part of the walls of the or each tubular passage can be constructed from selectively permeable and/or porous material in a number of different ways. By way of example only a selectively permeable and/or porous sheet can be held in place over a groove with suitable geometry cut into a piece of material to form the tubular passage. Alternatively two sheets of selectively permeable and/or porous material can be held in place on either side of a separator to construct the tubular passage. Alternatively a single sheet can be bent round to form a tubular passage. A hollow tube of selectively permeable and/or porous material can also be used to construct all or part of the tubular passage. By way of example only, a variety of methods are available to shape the tube into a die as is commonly known to a craftsman skilled in the art.

The interior walls may furthermore be substantially smooth or may be provided with “ridges” or bumps on at least part of the wall. The presence of such modifications in the walls aids in the draw-down process. Such ridges or bumps are typically less than 10% of the diameter of the tubular passage.

The use of selectively permeable and/or porous walls of substantially all or part or parts of the tubular passage(s) enables the proper control within desired limits of, for example, the concentration of fibre-forming material; solute composition; ionic composition; pH; dielectric properties; osmotic potential and other physico chemical properties of the dope within the tubular passage by applying the well-known principles of dialysis, reverse dialysis, ultrafiltration and preevaporation. Electro-osmosis can also be used to control the composition of the dope within the tubular passage. It will be appreciated that a control mechanism receiving inputs relating to the product being formed, for example the diameter of the extruded product and/or the resistance countered in the tubular passage, such as during extrusion through the outlet of the tubular passage, can be used to control, for example, polymer concentration, solute composition, ionic composition, pH, dielectric properties, osmotic potential and/or other physicochemical properties of the dope within the tubular passage.

The selective permeability and/or porosity of the walls of the or each tubular passage may also allow for the diffusion through the walls of further substances into the tubular passage(s) provided that these have a molecular weight lower than the exclusion limit of the selectively permeable material from which the walls of the tubular passage(s) are constructed. By way of example only the additional substances added to the dope in this manner may include surfactants; dopants; coating agents; cross-linking agents; hardeners; and plasticizers. Larger sized aggregates can be passed through the walls of the tubular passage if it is porous rather than being simply semipermeable.

The compartments surrounding the walls of the tubular passage or passages may act as one or more treatment zones or baths for conditioning the fibre as it passes through the tubular passage(s). Additional treatment can occur after the material has exited the outlet of the tubular passage.

One or more regions of the or each tubular passage may be surrounded by one or more compartments arranged consecutively so as to act as a jacket or jackets to hold solution, solvent, gas or vapour in contact with the outer surface of the selectively permeable walls of the tubular passage(s). Typically solution, solvent, gar or vapour is circulated through the compartment or compartments. The walls of the compartment or compartments are sealed to the outer surface of the wall or walls of the tubular passage(s) by methods that will be understood by a person skilled in the art. The compartment or compartments serve to control the chemical and physical conditions within the or each tubular passage. Thus the compartments surrounding the tubular passage(s) serve to define the correct processing conditions within the dope at any point along the tubular passage(s). In this way parameters such as the temperature; hydrostatic pressure; concentration of fibre-forming material; pH; solute; ionic composition; dielectric constant; osmolarity or other physical or chemical parameter can be controlled in different regions of the tubular passage as the dope moves down the length of the die. By way of example only, continuously graded or stepped changes in the processing environment can be obtained.

Conveniently a selectively permeable/porous membrane can be used to treat one side of a forming extrusion in a different way to the other side. This can be used, for example, to coat the extrusion or remove solvent from it asymmetrically in such a way that the extrusion can be made to curl or twist.

Sensors can be included in the tubular passage in order to measure parameters such as temperature, pressure, chemical composition, pH and/or light scattering. Using the results of the sensors, the process parameters of the extrusion process can be dynamically altered. Light scattering sensors can detect the presence, size and distribution of particles within the dope and can, with appropriate software, determine whether the dope is in a sol or gel state.

All or part of the draw down process may typically occur within the tubular passage of the die rather than at the outer face of the die assembly as occurs in existing spinning apparatus. The former arrangement offers advantage over existing spinning apparatus. The distortion of molecular alignment due to die swell is avoided. The region of the die assembly after the internal commencement of the draw down taper can be used to apply coatings or treatments to the extrusion. Further, the last part of the die assembly is water lubricated by the solvent-rich phase surrounding the extrusion.

By way of example only the apparatus can be used for forming fibres from dopes containing solutions of recombinant spider silk proteins or analogues or recombinant silk worm silk proteins or analogues or mixtures of such proteins or protein analogues or regenerated silk solution from silkworm silk. When these dopes are used it is necessary to store the dope at a pH above a critical value to prevent the premature formation of insoluble material. It will be appreciated that other constituents may be added to the dope to keep the proteins or protein analogues in solution. These constituents may then be removed through the semipermeable and/or porous walls when the dope has reached the appropriate portion of the tubular passage in which it is desired to induce the transition from liquid dope to solid product, e.g. thread or fibre. The dope within the tubular passage can then be brought by dialysis against an appropriate acid or base or buffer solution to a pH value at or close to the critical value to induce the aggregation or conformation change in one or more of the constituent proteins of the dope. Such a pH change will promote the formation of an insoluble material. A volatile base or acid or buffer can also be diffused through the walls of the or each tubular passage from a vapour phase in the surrounding compartment or jacket to adjust the pH of the dope to the desired value. Vapour phase treatment to adjust the pH can also occur after the extruded material has left the outlet of the die assembly.

The draw rate and length, wall thickness, geometry and material composition of the or each tubular passage may be varied along its length to provide different retention times and treatment conditions to optimise the process.

One or more regions of the walls defining the or each tubular passage can be made impermeable by coating their inner or outer surfaces with a suitable material to modify the internal environment in a length of the tubular passage using any coating method as will be understood by a person skilled in the art.

The inner surface of the walls of the or each tubular passage can be coated with suitable materials to reduce the friction between the walls of the tubular passage and the dope or fibre. Such a coating can also be used to induce appropriate interfacial molecular alignment at the walls of the tubular passage in liquid crystalline polymers when these are included in the dope.

A further embodiment allows for one or more additional components to be fed to the start of the or each tubular passage via concentric openings to allow two or more different dopes to be co-extruded through the same tubular passage allowing for the formation of one or more coats or layers to the fibre or fibres.

A further embodiment utilises a dope prepared from a phase separating mixture containing two or more components which, for example, may be different proteins. The removal or addition of components through the selectively permeable and/or porous material can be used to control the phase separation process to produce droplets of one or more components typically with a diameter of 100 to 1000 nm within the bulk phase in the final extrusion. These can be used to enhance the toughness and other mechanical properties of the extrusion. The use of a convergent or divergent die conveniently induces elongational flow in the droplets to produce orientated and elongated filler particles or voids within the bulk phase. A convergent die will orientate and elongate such droplets in a direction parallel to that of the formed product whereas a divergent die will tend to orientate the droplets in hoops transverse to the direction of flow of each particle within the tubular passage of the dope. Both types of arrangement can be used to enhance the properties of the formed product. Further it will be understood that the selectively permeable and/or porous walls of the or each tubular passage can be used to diffuse in or out chemicals to initiate the polymerisation of filler particles.

The extrusion apparatus with one or more tubular passages surrounded by a compartment or compartments to act as jackets can be constructed by one or two stage moulding or other methods known to a person skilled in the art. The jackets do not have to completely surround the tubular passage. The jackets can be of different shape as appropriate. It will be appreciated that a moulding process can be used to create simple or complex profiles for the or each tubular passage and the outlet of the die assembly. Very small flexible lips can be formed, e.g. moulded, at the outlet to prevent the escape of the contents of the treatment bath and act as a restriction to enable an optional additional air drawing stage or wet drawing after the material has left the outlet of the die assembly should this be required. The microscopic profile of the inner surface of the lips at the outlet can be used to modify the texture of the surface coating of the extruded material.

In one embodiment of the invention, the extrusion apparatus is manufactured using the so-called LIGA process. The principles of the LIGA process are described in the book “Angewandte Mikrotechmik. LIGA-Laser-Feinwerktechnik” by Rainer Brück and Andreas Schmidt (Herausgeber). Munich: Hanser Fachbuch, 2001.

In the LIGA prcess, an electrically-conductive base plate is covered with a layer of resist. The resist is typically a poly (methyl methacrylate) (termed PMMA) based resist, but may also be a poly-(lacitde-coglycolide) resist, a polyimide resist or another suitable resist. A resist pattern is formed in the resist by lithographic thechniques. The lithographic techniques used include photolithographic, UV-lithographic or X-ray lithographic process. The smallest structures are created using synchrotron radiation. Alternatively, the resist pattern could be formed by laser or electron ablation.

A layer of metal, typically nickel, copper, gold, NiFe or NiP, is subsequently placed over the resist pattern using an electroformation process. The electrically-conductive base plate is removed and the remaining resist pattern dissolved to produce a mould insert. The mould insert is then filled with a plastic moulding compound from which the extrusion apparatus is moulded.

By way of further example only, the jackets and supports for the tubular passages can also be constructed from two or more components, by laser ablation or constructed in other ways as will be understood by a person skilled in the arts. It will be appreciated that this method of construction is modular and that a number of such modules can be assembled in parallel to produce simultaneously a number of fibres or other shaped products. Sheet materials can be produced by a row or rows of such modules. Such a modular arrangement allows for the use of manifolds to supply dope to the inlet of the tubular passage(s) and to supply and remove processing solvents, solutions, gases or vapours to and from the jacket or jackets surrounding the tubular passages. Additional components may be added if desired. Potential modifications to the arrangements shown will be apparent to persons skilled in the art.

Other methods of constructing spinning apparatus in which the walls of the tubular passages are substantially or partially constructed from semipermeable and/or porous material or materials will be known by a person skilled in the art. By way of example only these include micro-machining techniques, laser ablation techniques and lithography techniques. In addition it will be appreciated that walls of the tubular passages substantially or partially constructed from semipermeable/porous material can be incorporated into other types of spinning apparatus, such as electrospinning apparatus.

The or each tubular passage may be made self-sing and self-cleaning. It will be appreciated that blockage of spinning dies during the commercial production of extruded materials is time-consuming and costly. To overcome this difficulty, the walls of the tubular passage may be constructed by two or more jackets arranged in sequence. The pressure in each of these jackets can be varied independently by methods that will be understood by a craftsman skilled in the art. Pressure changes in the jackets can be used to change the diameter of different regions of the tubular passage in a manner analogous to a peristaltic pump to pump the dope to the outlet to commence the drawing of fibres or to clear a blockage. Thus a decrease in pressure in a jacket towards the outlet end of the tubular passage will dilate the elastic walls of the tubular passage within the jacket. If the pressure is now raised in a second jacket closer to the input end of the tubular passage a region of the walls of the tubular passage running through this jacket will tend to collapse forcing the dope towards the outlet. Alternatively, the pressure in the dope fed to the tubular passage could be increased causing the diameter of the elastic tubular passage walls to increase. It will be appreciated that both methods could be used together or consecutively. With both methods, the elasticity of the passage walls enables the diameter of the tubular passage to be increased reducing the resistance to flow. With both methods it is to be noted that increasing the pressure of the dope will also assist in start up and in clearing blockages in the tubular passage. It will also be appreciated by way of example only that the use of rollers such as are used in peristaltic pumps can be used as an alternative means of applying pressure to pump dope to the outlet to commence spinning or to clear a blockage.

The pressure in the sealed compartments surrounding the tubular passage(s) may be controlled to define and modify the geometry of the tubular passage to optimise spinning conditions. It will be also appreciated that the semipermeable or porous membrane can be used to introduce agents to help clean blocked dies. Such agents include ammonia vapour or solutions, including dilute solutions, of alkalis or alkaline buffers.

If the or each tubular passage has a convergent or divergent geometry along all or part of its length, filler particles or short fibres included in the dope may be orientated as they flow through the tubular passage by exploiting the well understood principle of elongational flow. It will be understood that the substantially axial orientation of such filler particles or short fibres will be produced by a convergent tubular passage while a divergent one will produce orientation in the hoop direction that is approximately transverse to the long axis of the extruded material. Both patterns of orientation confer additional useful properties on the fibre. It will be appreciated that a convergent or divergent geometry of all or part of the or each tubular passage will also serve to elongate and orientate small fluid droplets of an additional solvent or solution or other phase or phases or additional unpolymerised polymer or polymers present in the dope as supplied to the tubular passage or arising by a process of phase separation within the dope. The presence of elongated phase separation within the dope. The presence of elongated and well orientated narrow inclusions formed by either a convergent or divergent tubular passage can be used to confer additional useful properties to the extruded material.

The apparatus my be arranged in such a way that two or more fibres are formed in parallel and twisted around each other or crimped or wound onto a former or coated or left uncoated as desired. The fibres can be drawn through a coating bath and subsequently through a convergent die to give rise to a “sea and island” composite material as will be understood by a person skilled in the art. One or more rows of dies or one or more dies with slit or annular opening can be used to form sheet materials.

### BEST MODE FOR CARRYING OUT THE INVENTION

FIG. 1 shows a schematic apparatus for the formation of extruded materials from a extrusion solution such as liquid crystalline polymer or other polymers or polymer mixtures. The apparatus comprises a dope reservoir 1 containing dope 25; a pressure regulating valve or pump means 2 which maintains a constant output pressure under normal operating conditions; a connecting pipe 3; and a spinning die assembly 4 comprising at least one spinning tube or die further described in FIGS. 2 to 5. A take-up drum 5 of any known construction draws out at a draw rate and reels up extruded material at a constant uptake tension exiting from the outlet of the die assembly 3. The pressure regulating valve or pump means 2 may be any device normally producing a constant pressure commonly known to a person skilled in the art.

The arrangement shown in FIG. 1 is purely exemplary and additional components to the arrangement shown in FIG. 1 will be apparent to persons skilled in the art. In use dope 25 is passed from the feedstock reservoir 1 at a constant low pressure by means of the regulating valve or pump means 2 via the connecting pipe 3 to the inlet of the spinning die assembly 4.

The apparatus may further comprise one or more sensors, shown schematically at 70. The one or more sensors 70 are connected to a microprocessor 75 which receives the output from the one or more sensors 70. The sensors 70 are preferably integral to the die assembly 4, i.e. they are constructed at the same time and in the same manufacturing step. An output of the microprocessor 75 can be used to regulate the parameters of the extrusion process such as the extrusion rate, uptake tension draw rate and pH. It will be furthermore understood that components of the microprocessor 75 can be made integral to the apparatus. In particular the components can be fabricated with the other parts of the apparatus.

The die assembly 4 is shown in greater detail in FIGS. 2 and 3 and comprises a first spinning tube or die 8 upstream of a second spinning tube or die 12, the dies together defining a tubular passage 17 for spinning solution 25 through thee die assembly 4. The die 12 has an interior wall 18 and is divided into an initial zone 60 and a subsequent zone 62. The dies 8 and 12 are made of semipermeable and/or porous material, such as cellulose acetate membranes or sheets. Other examples of suitable semipermeable and/or porous materials are diethylaminoethyl or carboxyl or carboxymethyl groups which help to maintain protein-containing dopes in a state suitable for spinning. Hollow-fibre membranes material, such hollow-fibre membranes being made from polysulfone, polythyleneoyide-polysulfone blends, silicone or polyacrylonitrile can also be used. The exclusion limit selected for the semipermeable membrane will depend on the size of the small molecular weight constituents of the spinning dope 25 but is typically less than 12 kDa.

The die 8 is held at its upstream end by a tapered adaptor 6 positioned at the inlet end of the die assembly 4 and at its downstream end by a tapered adaptor 7 positioned internally in the die assembly 4. The die 8 is held at its upstream end by the adaptor 7 and at its downstream end by a spigot 13 at the outlet of the die assembly 4. The die 8 has a convergent, preferably hyperbolic, internal passage and the geometrical taper is preferably continued with the internal passage of the die 12. This can be achieved during construction by softening a semipermeable tube or die an a warmed suitably tapered mandrel, or by other methods as will be appreciated by a craftsman skilled in the art before fitting the spinning tube or die into the apparatus. The internal passages of the dies 8 and 12 together provide the tubular passage 17 for spinning solution from the inlet to the outlet of the die assembly 4.

A jacket 9 surrounds the die 8 and may contain a fluid, e.g. a solvent, solution, gas or vapour to control the processing conditions within the spinning tube or die 8. The jacket 9 is fitted with an inlet 10 and an outlet 11 to control flow of fluid into and out of the jacket. A further jacket 14 surrounds the tube or die 12 and is fitted with a fluid inlet 15 and a fluid outlet 16 to enable fluid, e.g. solvent, solution or gas, to be passed into and out of the jacket 14 in contact with the semipermeable/porous walls of the die 12.

As an alternative to the die 8 shown having semipermeable walls, a die 8 may be constructed from material which is not semipermeable or porous but which is preferably tapered, e.g. convergently, and may be temperature-controlled by circulation fluid at a predetermined temperature through the jacket 9.

In operation spinning solution or dope 25, e.g. a polymer solution, is fed to the inlet of the die 8, as the dope passes along the tubular passage 17 it is treated firstly as it passes through the die 8 and secondly as it passes trough the die 12. The fluid passing through the jacket 9 may merely serve to heat or maintain the dope 25 at the correct temperature or provide the correct external pressure to the walls of the die 8. in this case it is not essential for the walls of the die to be made of semipermeable and/or material. The temperature of the dies 8 and 12 for the extrusion of protein-containing dopes 25 should typically be maintained at a temperature of about 20° C. but spinning may be carried out at temperatures as low as 2° C. and as high as 40° C. The temperature of the dies 8 and 12 for the extrusion of dopes can more generally be as high as 100° C. providing that the material is not destroyed at this temperature. The pressure of the fluid, liquid or gas, in the jackets surrounding the walls of the tubular passage 17 is typically maintained at a pressure close to that at which the dope 25 is supplied to the die assembly 4. However the pressure can be somewhat higher or lower depending on the geometry of the dies and the strength of the generally flexible semipermeable and/or porous membrane. “Chemical” treatment of the dope 25 occurs during “draw down” as the dope 25 passes through the die 12 although chemical treatment may also occur as the dope 25 passes through the die 8 if the walls of the latter are at least partly made of semipermeable material. In FIGS. 2 and 3, the abrupt pulling away of the dope 25 from the walls of the die 12 at 12A indicates the internal draw down of the “fibre”. This occurs at the boundary of the initial zone 60 and the subsequent zone 62. This is a feature of the invention as draw down in existing processes always start at the outer opening 13 of a die (i.e. the extrusion orifice) and not before. The pulling away of the “fibre” from the die walls at 12A occurs at a place in the tubular die 12 where the force required to produce extensional flow to create a new surface just falls below the force required to flow the dope through the die 12 in contact with the die walls. This is the position at which the surface energy of the interior wall 18 becomes lower than the surface energy of the dope 25. The position of 12A will depend on: the changing rheological properties of the dope; the rate and force of drawing; the surface properties of the die 12; the surface properties of the lining of the die 12; and the properties of the dope and the aqueous phase surrounding the dope. The position of 12A should be at least 0.5 mm from the outer opening or spigot 13.

In one embodiment of the invention, a surface 66 of the interior wall 18 of the die 12 is provided with ridges 68 to facilitate the draw down of the fibre at position 12A. This is shown in FIGS. 6 and 7. These ridges 68 have a height of typically less than 10% of the diameter of the die 12. Typically the diameter of the die 12 at this position is 20 μm and the ridges 68 are 0.5 μm high. The ridges 68 could be between 100 nm and 20 μm high. It is believed that draw-down of the fibre occurs because in the die 8 and the initial zone 60 of the die 12, rod-shaped units 64 in the dope 25 are arranged substantially perpendicular to the interior wall 18. At position 12A, these rod-shaped units start to “tumble” within the dope 25 and thus increase the viscosity and decrease the surface energy of the dope 25. This produces changes in the rheology of the dope which, when aided by the presence of the ridges 68 on the interior wall 18, helps to initiate the drawing down of the fibre.

It will be appreciated that the temperature, pH, osmotic potential, colloid osmotic potential, solute composition, ionic composition, hydrostatic pressure or other physical or chemical factors of the solution, solvent gas or vapour supplied to the jacket(s) control or regulate the conditions inside the tubular passage 17 and thus the extrusion process as is commonly understood by a craftsman skilled in the art. Chemicals in the fluid supplied to the jacket(s) 9 are able to pass through the semipermeable and/or porous walls of the tubular passage 17 to “treat” the dope 25 passing therethrough. It is also possible for chemicals in the dope 25 to pass outwardly through the semipermeable and/or porous walls of the tubular passage 17. The fluids supplied to the dope 17 will obviously depend on the type of dope 25 used and the semipermeable and/or porous membranes used. However, by way of example only, for the spinning of concentrated spider major ampullate gland protein solutions, the jacket 9 may contain 100 mM Tris or PIPES buffer solution, typically at a pH of 7.4, and 400 mM sodium chloride to help maintain the folded state of the protein. The jacket 14 may contain 100 mM ammonium acetate buffer solution at al lower pH, typically less than 5.0, and 250 mM potassium chloride to encourage the unfolding/refolding of the protein. High molecular weight polyethylene glycol can be added to the solution in both jackets to maintain or reduce the concentration of water in the dope 25.

It will be realised that the spinning tube or die 12 can be hanked or coiled or arranged in other ways between the tapered collar 7 and the spigot 13. The diameter and cross-sectional shape or the exit 13 can be varied or adjusted to suit the diameter and cross sectional shape of the formed material. For a formed product having a circular cross-sectional, the typical diameter of the outlet is from 1 to 100 μm and the typical diameter of the inlet to the tubular passage 17 would be from 25 to 150 times greater than the outlet diameter depending on the extent of the extensional flow. It will be appreciated that the arrangements and proportions shown in FIG. 2 are purely exemplary and thus that additionally components may be added if desired. Potential modifications to the arrangements shown in FIG. 2 will be apparent to persons skilled in the art.

FIG. 4 shows a module containing three spinning tubes or dies 12 mounted within a housing defining three “jackets” 14, the same numbering being used as in the previous embodiments to identify the same or similar parts. The arrangements and proportions shown in FIG. 2 are purely exemplary and thus additional components may be added if desired. Potential modifications to the arrangements shown in FIG. 4 will be apparent to persons skilled in the art, including the provision of fewer or more dies 12 or jackets 14.

FIG. 5 shows how two or more modular units constructed from the apparatus shown in FIG. 4 can be held together to enable a plurality of extruded fibres to be produced. It will be appreciated that the arrangements and proportions shown in FIG. 5 are purely exemplary and thus additional components may be added if desired. Potential modifications to the arrangements shown in FIG. 5 will be apparent to persons skilled in the art.

The permeability or porosity of the walls of the tubular passage may be the same throughout the length of the latter. Alternatively, however, if the tubular passage 17 passes through more than one treatment zone the permeability/porosity of the walls of the tubular passage may change from treatment zone to treatment zone by using different semipermeable or porous materials for the walls of the tubular passage. Thus the walls of the tubular passage 17 may comprise: semipermeable material of the same permeability throughout the length of the tubular passage; semipermeable material of different permeability for different portions of the tubular passage; porous material of the same porosity throughout the length of the tubular passage 17; porous material of different porosity for different portions of the passage; or semipermeable material for one or more portions of the length of the tubular passage and porous material for one or more other portions of the tubular passage. As mentioned above, some portions of the walls of the tubular passage may be non-permeable. By way of example only, suitable semipermeable materials are: cellulose derivatives, expanded PTFE, polysulfone, polyethylenoxide-polysulfone blends, and silicone polyacrylonitrile blends. By way of example only, the suitable porous materials are: polyacrylate, poly (lactide-co-glycolide), porous PTFE, porous silicon, porous polyethylene, cellulose derivatives and chitosan.

It will be appreciated that the apparatus is suitable for the information of fibres of sheets from all solutions of lyotropic liquid crystal polymers whether synthetic or man-made or natural or modified or copolymer mixtures or solutions of recombinant proteins or analogues derived from them or mixtures of these. By way of example only these include collagens; certain cellulose derivatives; spidroins, fibroins; recombinant protein analogues based on spidroins, or fibroins, and poly (p-phenylene terephthalates). The method is also suitable for use with other polymers or polymer mixtures provided that they are dissolved in solvents, whether aqueous or non-aqueous, protein solutions, cellulose or chitin solutions. It will also be appreciated that the use of one or more semipermeable and/or porous treatment zones can be used for dies or die assemblies having essentially annular or elongated slit openings used for the formation of sheet materials.

1. An extrusion apparatus comprising:
at least one first reservoir connected at a first end to a first opening of a plurality of regulatory modules containing passages, through which material is excludable, wherein the extrusion apparatus has at least 1000 passages per square meter cross-section.

2. An extrusion apparatus according to claim 1, wherein the regulatory module additionally comprises at least one second reservoir.

3. An extrusion apparatus according to claim 2, wherein the second reservoir is fluidly connected to at least an opening in at least one of the passages.

4. An extrusion apparatus according to claim 1, further comprising sensors.

5. An extrusion apparatus according to claim 1, further comprising at least one sensor selected from the group consisting of pressure sensors, temperature sensors, chemical sensors, pH sensors and light-scattering sensors.

6. An extrusion apparatus according to claim 1, wherein at least one of the regulatory modules comprises at least one individual sensor (70).

7. An extrusion apparatus according to claim 4, wherein the sensors are integral to the regulatory modules.

8. An extrusion apparatus according to claim 1, wherein the regulatory modules further comprise at least one pump.

9. An extrusion apparatus according to claim 1, wherein the regulatory modules further comprise at least one pump selected from the group consisting of piezoelectric pumps and vibration pumps.

10. An extrusion apparatus according to claim 1, wherein the passages comprise tubular passages having flow inlets.

11. An extrusion apparatus according to claim 1, wherein said passages have interior walls comprising a permeable material.

12. An extrusion apparatus according to claim 1, wherein the regulatory modules are injection molded.

13. An extrusion apparatus according to claim 1, wherein the regulatory modules (4) are formed by ablasion.

14. An extrusion apparatus according to claim 1, wherein in operation the material is drawn down at a first distance at least 0.5 mm from an outer exit opening within the passages.

15. An extrusion apparatus according to claim 1, wherein a component of the material in an initial zone in one of the passages forms rod-shaped units that are substantially perpendicular to an internal surface of the passage.

16. An extrusion apparatus according to claim 1, wherein a component of the material in a subsequent zone of one of the passages has rod-shaped units that tumble as material flows within the passage.

17. An extrusion apparatus according to claim 1, further comprising a ridged surface having a plurality of ridges on an internal surface of the passages.

18. An extrusion apparatus according to claim 17, wherein height of the ridges is less than 10% of diameter of the passages.

19. An extrusion apparatus according to claim 17, wherein the ridged surface has a surface energy lower than surface energy of the material.

20. An extrusion apparatus according to claim 17, wherein the passages are tubular passages, and the ridges are substantially oriented along a long axis of the tubular passages.

21. An extrusion apparatus according to claim 17, wherein the ridges comprise hydrophobic material.

22. An extrusion apparatus according to claim 17, ridges are coated with hydrophobic material.

23. An extrusion apparatus according to claim 22, constructed and arranged so that draw down of material occurs substantially adjacent to the hydrophobic material coated on the rides.

24. (canceled)

25. An extrusion apparatus according to claim 1, further comprising cleaning apparatus.

26. An extrusion apparatus according to claim 25, wherein the cleaning apparatus comprises a permeable interior wall in said passages through which cleaning agents are introduced.

27. An extrusion apparatus according to claim 26, wherein the cleaning agents comprise alkaline fluids.

28. An extrusion apparatus according to claim 3, further comprising a microprocessor connected to at least one of the sensors.

29. An extrusion apparatus according to claim 28, wherein the microprocessor has an output for sending signals to regulate at least one parameter of the extrusion apparatus.

30. An extrusion apparatus, according to claim 28, wherein the microprocessor is integral to the regulatory modules.

31. An extrusion apparatus according to claim 1, wherein the extrusion apparatus is a spinning apparatus.

32. (canceled)
